(19) United States
(12) Patent Application Publication
(10) Pub. No.: US 2023/0180735 A1
(43) Pub. Date: Jun. 15, 2023

(54) Repurposed Mouse Pads

(71) Applicant: Shaun Arora, Chatsworth, CA (US)

(72) Inventor: Shaun Arora, Chatsworth, CA (US)

(21) Appl. No.: 17/549,782

(22) Filed: Dec. 13, 2021

(51) Int. Cl. A01M 3/02; B32B 25/04; B32B 25/14; B32B 9/04; B32B 9/02

(52) U.S. Cl. CPC A01M 3/022; B32B 25/042; B32B 25/14; B32B 9/043; B32B 9/025

(57) ABSTRACT

Aspects of the disclosure relate to bug swatters. In one example, a bug swatter apparatus is disclosed, which includes a handle and at least one flappable pad coupled to the handle. For this example, a portion of the at least one flappable pad is configured to flap behind the handle when the handle is swung. In another example, a method is disclosed, which includes obtaining at least one mouse pad and creating a repurposed form of the at least one mouse pad. For this example, the creating comprises attaching the at least one mouse pad to a handle. In a further example, yet another bug swatter apparatus is disclosed, which includes a handle and a flat surface coupled to the handle. For this example, the flat surface includes at least one layer of adhesive material.

### TECHNICAL FIELD

The subject disclosure generally relates to swatting bugs, and more specifically to an apparatus and methodology for repurposing mouse pads as bug swatters.

### INTRODUCTION

By way of background concerning conventional bug swatters, it is noted that most are made of plastic material. Manufacturing conventional bug swatters thus contributes to the proliferation of more plastic which harms the environment. With respect to performance, it is further noted that conventional bug swatters are typically lightweight, which limits their “whip” action. As a result, users often miss on their first few attempts to swat a bug. Conventional bug swatters are also notoriously difficult to keep clean. For instance, a swatted bug tends to stick to conventional bug swatters. And although a user may simply wipe the bug off, remnants of the bug will usually remain stuck between the openings of the bug swatter.

Accordingly, it would be desirable to provide an apparatus and methodology which overcomes these limitations. To this end, it should be noted that the above-described deficiencies are merely intended to provide an overview of some of the problems of conventional bug swatters, and are not intended to be exhaustive. Other problems with the state of the art and corresponding benefits of some of the various non-limiting embodiments may become further apparent upon review of the following detailed description.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects directed towards swatting bugs are disclosed. In one example, a bug swatter apparatus is disclosed, which includes a handle and at least one flappable pad coupled to the handle. For this example, a portion of the at least one flappable pad is configured to flap behind the handle when the handle is swung.

In another example, a method that facilitates repurposing mouse pads is disclosed. The method includes obtaining at least one mouse pad and creating a repurposed form of the at least one mouse pad. For this example, the creating comprises attaching the at least one mouse pad to a handle.

In a further example, yet another bug swatter apparatus is disclosed. The bug swatter apparatus includes a handle and a flat surface coupled to the handle. For this example, the flat surface includes at least one layer of adhesive material.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

Various non-limiting embodiments are further described with reference to the accompanying drawings in which:

FIG. 1 illustrates a perspective view of an exemplary bug swatter apparatus in accordance with an aspect of the subject specification;

FIG. 2 illustrates a front view of an exemplary bug swatter apparatus in accordance with an aspect of the subject specification;

FIG. 3 illustrates a flappable pad of an exemplary bug swatter apparatus in a neutral angle in accordance with an aspect of the subject specification;

FIG. 4 illustrates a flappable pad of an exemplary bug swatter apparatus in a negative angle in accordance with an aspect of the subject specification;

FIG. 5 illustrates a flappable pad of an exemplary bug swatter apparatus in a positive angle in accordance with an aspect of the subject specification;

FIG. 6 illustrates exemplary configurations of a bug swatter apparatus in accordance with various aspects of the subject specification;

FIG. 7 illustrates an exemplary bug swatter apparatus with a rigid support in accordance with an aspect of the subject specification;

FIG. 8 illustrates an exemplary bug swatter apparatus with a layer of adhesive material in accordance with an aspect of the subject specification;

FIG. 9 illustrates exemplary configurations of a bug swatter apparatus with adhesive material in accordance with various aspects of the subject specification;

FIG. 10 illustrates an exemplary assembly of a bug swatter apparatus in accordance with an aspect of the subject specification;

FIG. 11 is a block diagram illustrating an exemplary environment that facilitates repurposing mouse pads in accordance with an aspect of the subject specification;

FIG. 12 is a flow diagram illustrating an exemplary methodology that facilitates repurposing mouse pads in accordance with an aspect of the subject specification; and

FIG. 13 illustrates an exemplary logo management component in accordance with an aspect of the subject specification.

### DETAILED DESCRIPTION

### Overview

As discussed in the introduction, it would be desirable to create a bug swatter that not only performs better than conventional bug swatters, but is also easier to clean and more friendly to the environment. In a particular embodiment, discarded and overstocked mouse pads are repurposed as bug swatters by attaching them to handles. Such bug swatters are heavier and more dense than conventional bug swatters, which creates a greater whip action. Mouse pads also have a smooth surface that make them easier to clean than conventional bug swatters, which have openings where bug remnants often remain between uses. Furthermore, by repurposing discarded and overstocked mouse pads, the aspects disclosed herein desirably avoid having to source new plastic material, which is wasteful and harmful to the environment.

### Exemplary Bug Swatter Embodiments

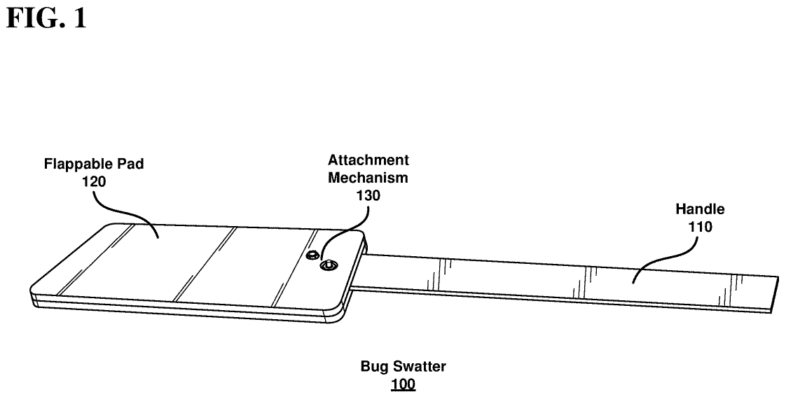

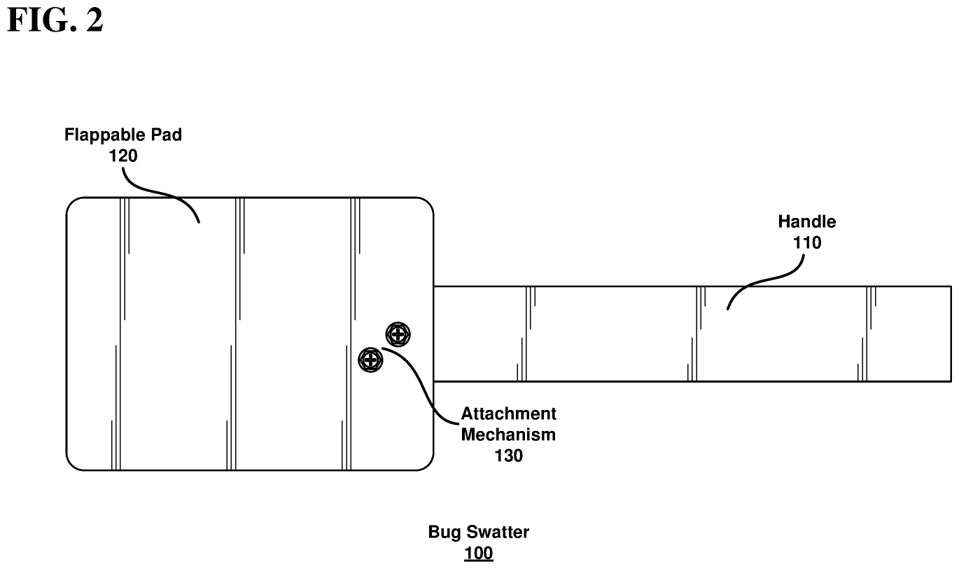

Turning now to FIGS. 1-5, an exemplary bug swatter 100 is provided in accordance with an aspect of the subject specification. For instance, FIG. 1 shows a perspective view of bug swatter 100, whereas FIG. 2 shows a front view of bug swatter 100. As illustrated, bug swatter 100 comprises a handle 110 coupled to flappable pad 120 via attachment mechanism 130 (e.g., screws). In a particular embodiment, it is contemplated that flappable pad 120 may be a soft mouse pad sourced from a repository of discarded and/or overstocked mouse pads. In general, however, it should be appreciated that flappable pad 120 may be any flappable object having similar physical characteristics as a conventional soft mouse pad (i.e., similar composition, weight, etc.), wherein conventional soft mouse pads typically measure 8×9 inches (200×225 mm), 8×10 inches (200×250 mm), or 12×14 (300×350 mm), and typically have a thickness of between 2 and 5 mm. For instance, in an exemplary embodiment, it is contemplated that flappable pad 120 can be made of at least one of rubber, neoprene, leather, or elastomer, wherein flappable pad 120 has a thickness of at least one millimeter and a density of at least 1150 kg/m³ (e.g., where flappable pad 120 measures 240×200 mm; has a thickness of 2 mm; and weighs 110 grams).

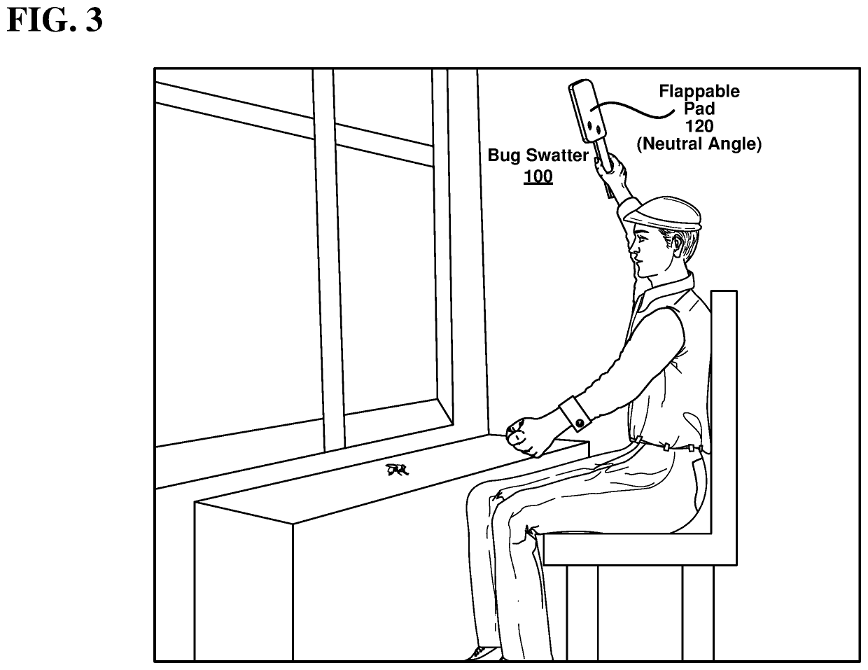

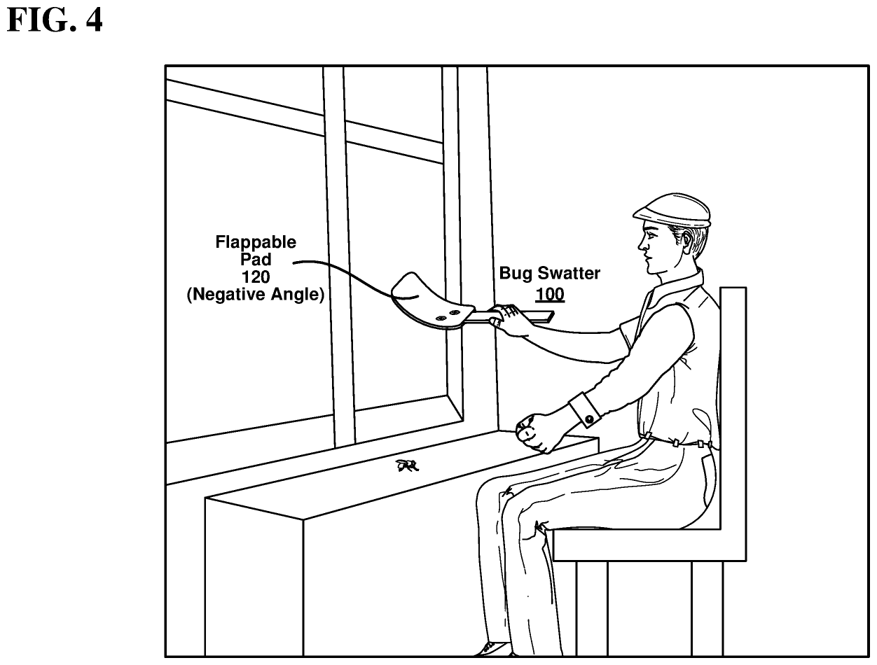

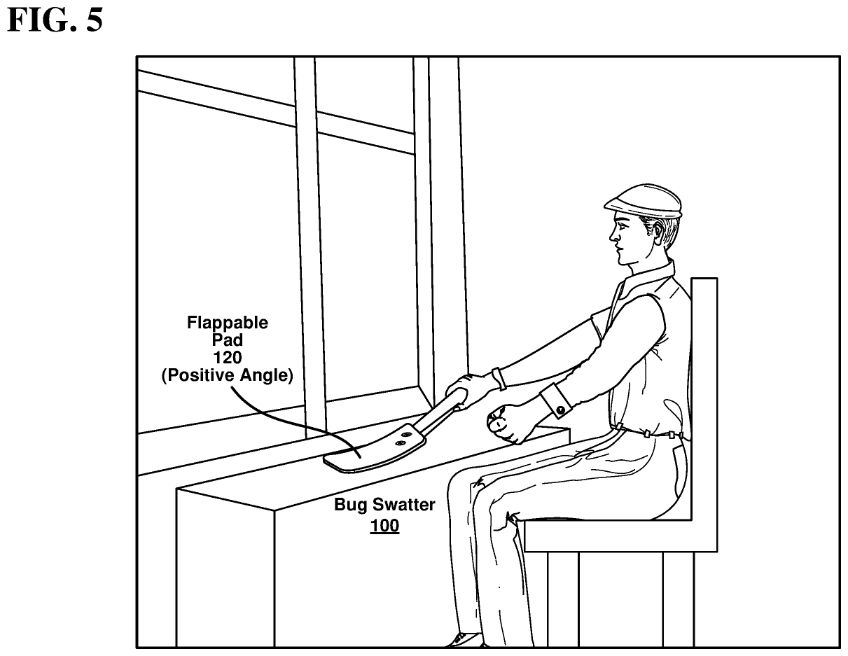

It should be appreciated that the “flap-ability” of flappable pad 120, as illustrated in FIGS. 3-5, is a particular characteristic that makes bug swatter 100 desirable over conventional bug swatters. Namely, the flap-ability of flappable pad 120 facilitates a greater whip action relative to conventional bug swatters, which makes it easier to successfully swat bugs on a first attempt. For instance, during use of bug swatter 100, flappable pad 120 may begin with no flap (i.e., a neutral angle), as illustrated in FIG. 3. When bug swatter 100 begins to move towards a bug targeted by the user, however, a portion of flappable pad 120 begins to flap behind handle 110 (i.e., a negative angle), as illustrated in FIG. 4. As bug swatter 100 continues to move towards the bug, the flap-ability of flappable pad 120 allows it to then flap forward (i.e., a positive angle) in a whip-like manner towards the targeted bug, as illustrated in FIG. 5. Moreover, because of the flap-ability of flappable pad 120 (i.e., due to the composition, weight, dimensions, etc. of flappable pad 120), a whip action is created which allows bug swatter 100 to accelerate faster than conventional bug swatters and ultimately impact a targeted bug with greater force.

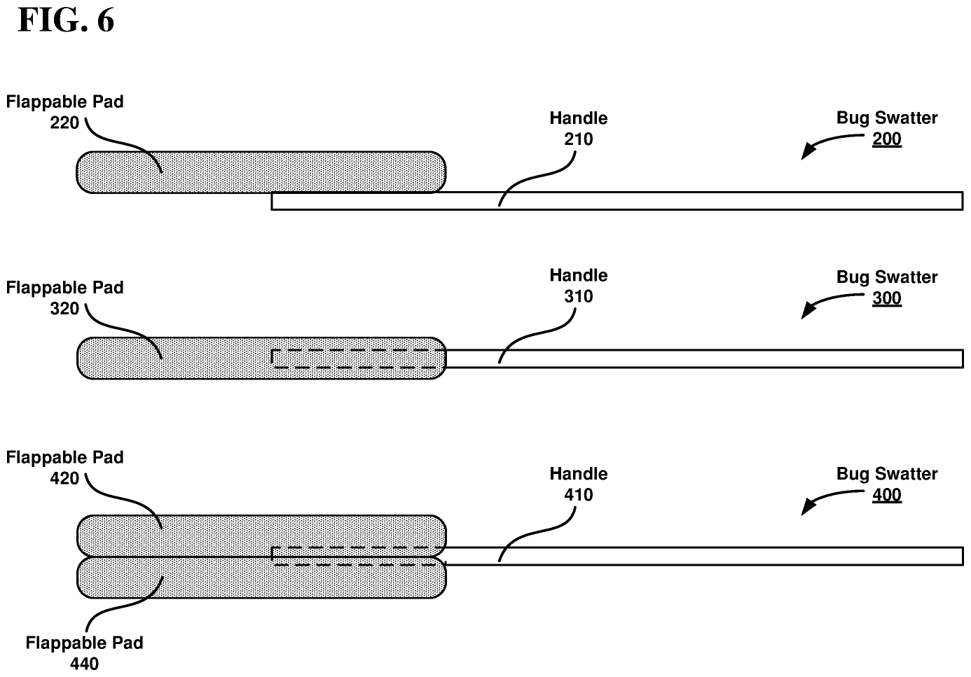

When assembling bug swatter 100, it should be appreciated that handle 110 may be coupled to flappable pad 120 via attachment mechanism 130 in any of various ways. Referring next to FIG. 6, various exemplary configurations of a bug swatter apparatus are provided in accordance with different aspects of the subject specification. For instance, a first configuration is contemplated in which a bug swatter 200 is assembled so that flappable pad 220 is attached to a particular side of handle 210. For this particular embodiment, if a conventional soft mouse pad is used for flappable pad 220, such assembly may ensure that the “strike” side of bug swatter 200 is the top side of the mouse pad, which typically has a fabric cover, rather than the bottom side, which is typically an uncovered foam or rubber composite. Namely, because the fabric cover side of a mouse pad is easier to clean than the uncovered bottom side, assembling bug swatter 200 so that the strike side is the fabric cover side of the mouse pad may be particularly desirable. It should also be noted that the fabric cover side of a mouse pad is a smooth surface, which is much easier to clean than the surface of conventional bug swatters which tend to have many openings.

In another aspect disclosed herein, configurations with two strike sides are also contemplated. For instance, a bug swatter 300 is contemplated in which handle 310 is coupled to flappable pad 320 via an insertion of handle 310 into a side of flappable pad 320, as shown. Alternatively, a bug swatter 400 is contemplated in which handle 410 is coupled to a first and second flappable pad, 420 and 440, wherein the second flappable pad 440 has a weight and dimensions substantially similar to the first flappable pad 420.

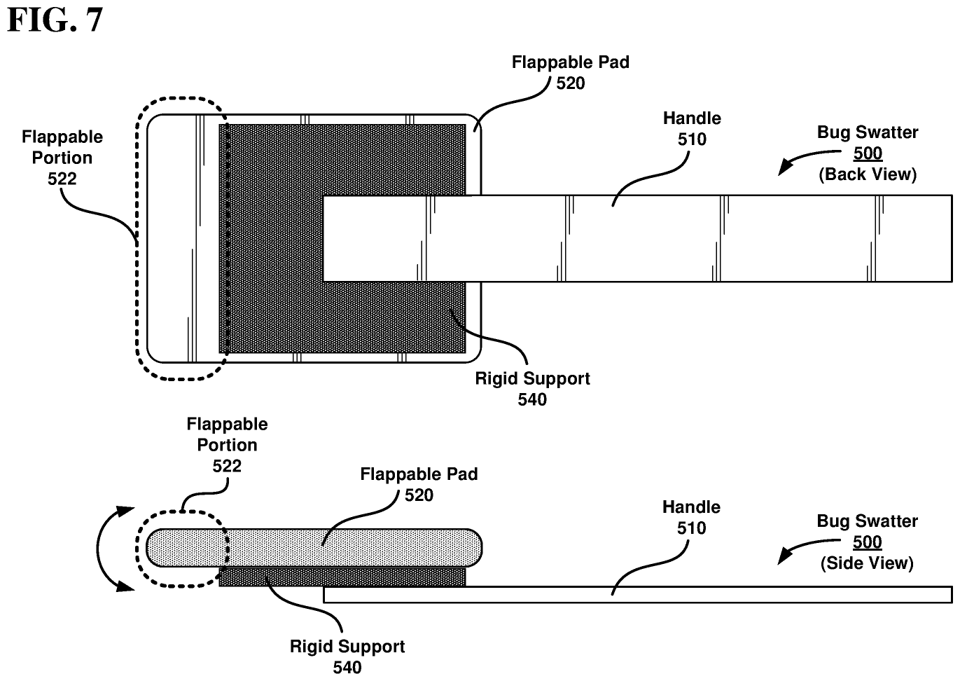

In yet another aspect disclosed herein, configurations in which the flap-ability of a bug swatter is increased/decreased, as desired, are also contemplated. For instance, as illustrated in FIG. 7, a bug swatter 500 is contemplated in which a rigid support 540 is coupled to handle 510 and flappable pad 520, as shown, wherein rigid support 540 has a lesser area than flappable pad 520. Here, it should be appreciated that the dimensions of the flappable portion 522 of flappable pad 520 depends on the dimensions of rigid support 540. Namely, it is contemplated that a larger/smaller flappable portion 522 of flappable pad 520 may be achieved by selecting a larger/smaller rigid support 540.

### Exemplary Adhesive Layer Embodiments

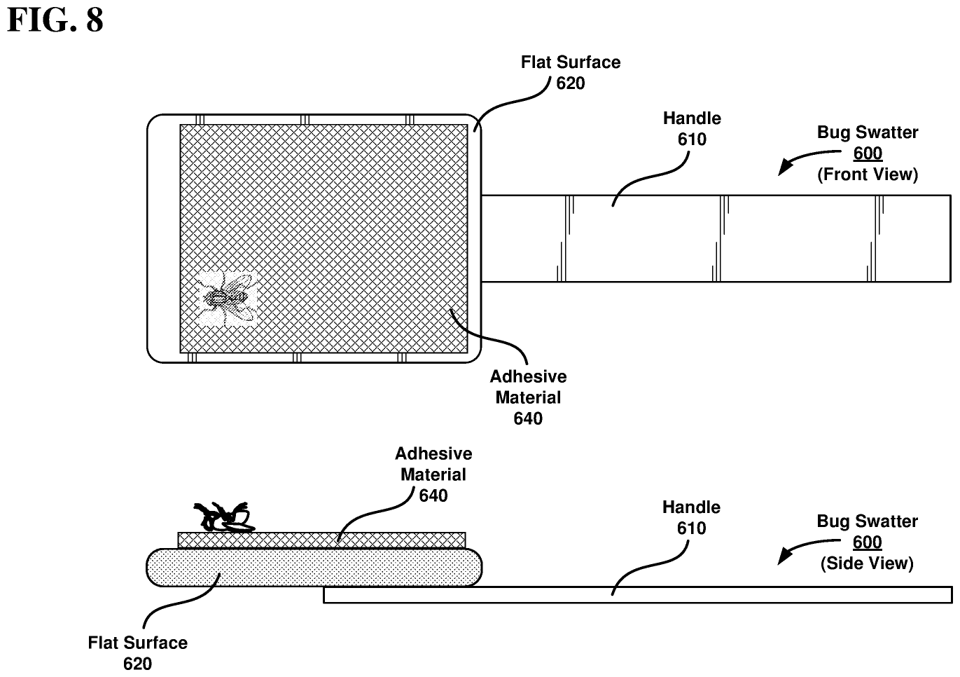

Aspects disclosed herein are also directed towards bug swatter designs that utilize adhesive material. In FIG. 8, for example, bug swatter apparatus with a layer of adhesive material is provided in accordance with an aspect of the subject specification. As illustrated, bug swatter 800 includes a handle 610 coupled to a flat surface 620, wherein the flat surface 620 includes at least one layer of adhesive material 640. Here, although flat surface 620 may be substantially similar to the aforementioned flappable pads (e.g., flappable pad 120), it should be noted that flat surface 620 does not necessarily need to be flappable.

During use, it should be appreciated that bug swatter 600 provides several advantages over conventional bug swatters. For instance, whereas conventional bug swatters generally require that a bug be on solid surface (e.g., a table, wall, etc.), bug swatter 600 enables a user to kill bugs in mid-air. Indeed, when conventional bug swatters make contact with a bug in mid-air, they often survive and/or are difficult to find after contact. When making mid-air contact with bug swatter 600, however, the bug sticks to adhesive material 640.

When killing bugs on a solid surface, bug swatter 600 provides several advantages over conventional bug swatters as well. For instance, killing bugs with conventional bug swatters often requires removing the carcass from the surface on which it was killed. Such removal, however, requires the user to handle the bug with their hands, which may be uncomfortable, especially if they lack something (e.g., tissue paper) to pick it up with. When swatting a bug with bug swatter 600 though, the bug carcass sticks to adhesive material 640.

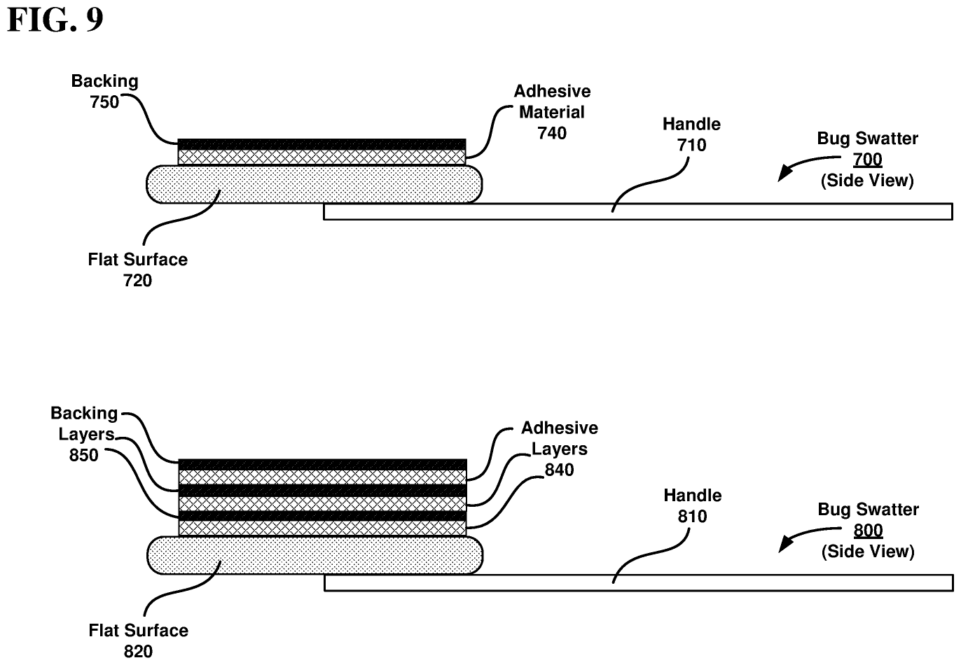

Referring next to FIG. 9, additional configurations of a bug swatter apparatus with adhesive material are provided in accordance with various aspects disclosed herein. For instance, a bug swatter 700 is contemplated that includes a handle 710 coupled to a flat surface 720, wherein the flat surface 720 includes a layer of adhesive material 740 sealed with a peelable backing 750. Within such embodiment, peelable backing 750 is configured to seal the adhesiveness of adhesive material 740 until the peelable backing 750 is removed. Such design allows the adhesiveness of adhesive material 740 to be preserved until the user intends to use bug swatter 700.

In another aspect disclosed herein, a bug swatter 800 is contemplated that includes a handle 810 coupled to a flat surface 820, wherein the flat surface 820 includes a plurality of removable layers of adhesive material 840. For instance, as illustrated in FIG. 9, the removable layers of adhesive material 840 may be respectively layered in between a plurality of peelable backing layers 850. During use, a user may begin by removing one of the peelable backing layers 850 so as to expose one of the removable layers of adhesive material 840. The user may then swat a bug, wherein the carcass of the swatted bug sticks to the exposed layer of adhesive material. The carcass can then be removed without making direct contact with the carcass by simply peeling away the top layer of adhesive material. By doing so, the subsequent peelable backing layer then becomes the top layer, which can remain until the user wishes to use bug swatter 800 again.

In an alternative embodiment, it is contemplated that a plurality of removable layers of adhesive material may be wrapped around a flat surface, rather than layered on a particular side. For instance, the plurality of removable layers may be segmented from each other via a plurality of perforations, similar to conventional lint rollers. During use, a user may thus swat a bug and remove the carcass by peeling away the exposed layer of adhesive material, and tearing it off at the subsequent perforation.

### Exemplary Methodology Embodiments

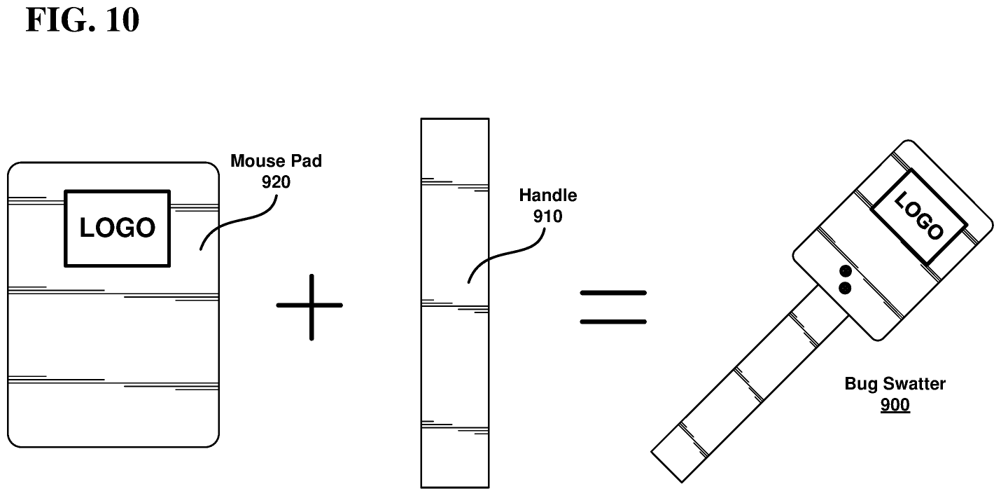

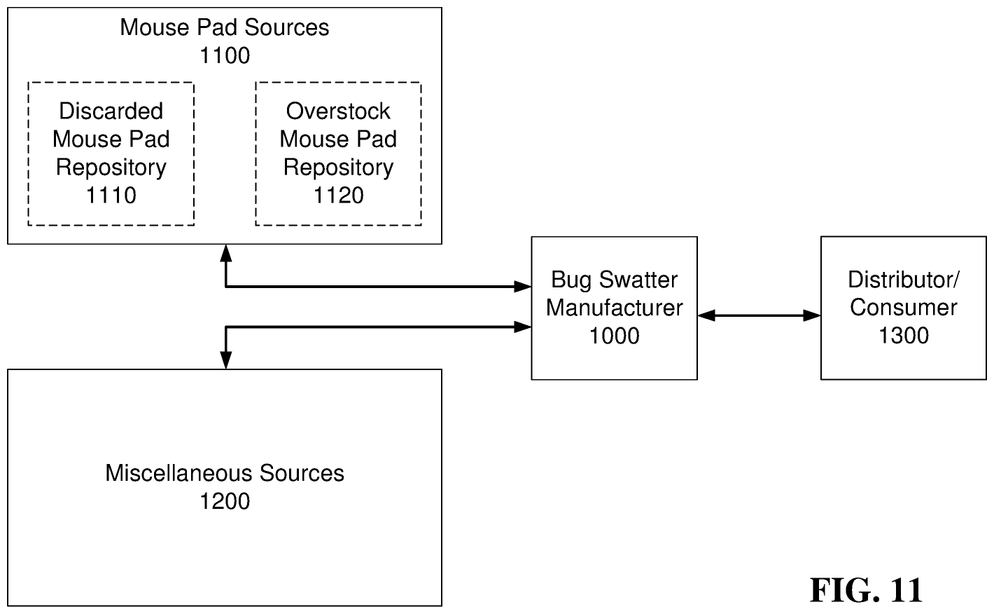

As previously mentioned, aspects disclosed herein are also directed towards repurposing discarded and overstocked mouse pads. In FIG. 10, an exemplary assembly of a bug swatter apparatus in accordance with such methodology is provided. As illustrated, it is contemplated that a mouse pad 920 may be coupled with a handle 910 to create a bug swatter 900, wherein bug swatter 900 may be substantially similar to any of the aforementioned bug swatter apparatuses disclosed above. As illustrated in FIG. 11, it is further contemplated that a bug swatter manufacturer 1000 may source mouse pad 920 from mouse pad sources 1100. For instance, mouse pad 920 may be sourced from a repository of discarded mouse pads 1110 (e.g., recycling centers) or a repository of overstocked mouse pads 1120 (e.g., companies, organizations, etc.). Bug swatter manufacturer 1000 may then source additional items to produce bug swatter 900 from miscellaneous sources 1200 including, for example, handle 910, as well as any other items disclosed above (e.g., screws for attachment mechanism 130, items for the adhesive layer embodiments, etc.). Once bug swatter 900 is manufactured, it is then contemplated that bug swatter manufacturer 1000 may sell bug swatter 900 to distributors/consumers 1300.

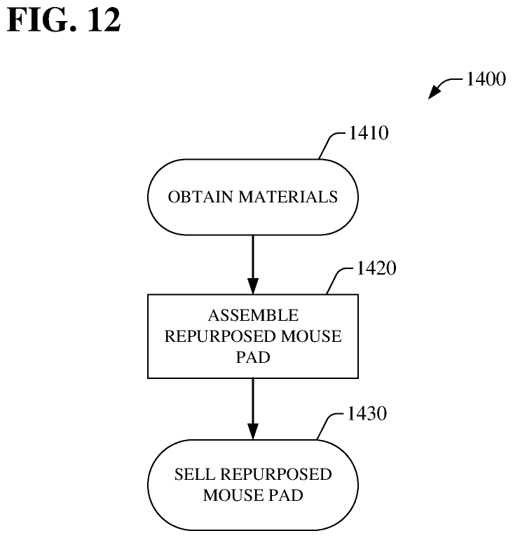

Referring next to FIG. 12 a flow diagram is provided illustrating an exemplary methodology that facilitates repurposing mouse pads in accordance aspects disclosed herein. As illustrated, process 1400 begins at act 1410 where bug swatter manufacturer 1000 obtains the materials necessary for making bug swatter 900 (e.g., via mouse pad sources 1100 and/or miscellaneous sources 1200). At act 1420, process 1400 continues with bug swatter manufacturer 1000 assembling the repurposed mouse pad (i.e., bug swatter 900) with the materials obtained at act 1410. Here, it should be appreciated that act 1420 may comprise cutting soft mouse pads to desired dimensions (e.g., cutting longer mouse pads in half). Process 1400 then concludes at act 1430 with bug swatter manufacturer 1000 selling the repurposed mouse pad (i.e., bug swatter 900) to distributors/consumers 1300. Here, it should be appreciated that the selling of the repurposed mouse pad may be to a source of the original mouse pad. For instance, a company with an overstock of company-branded mouse pads may contract with bug swatter manufacturer 1000, wherein bug swatter manufacturer 1000 obtains overstocked mouse pads from the company, then sells the mouse pads back to the company in repurposed form (i.e., as bug swatters).

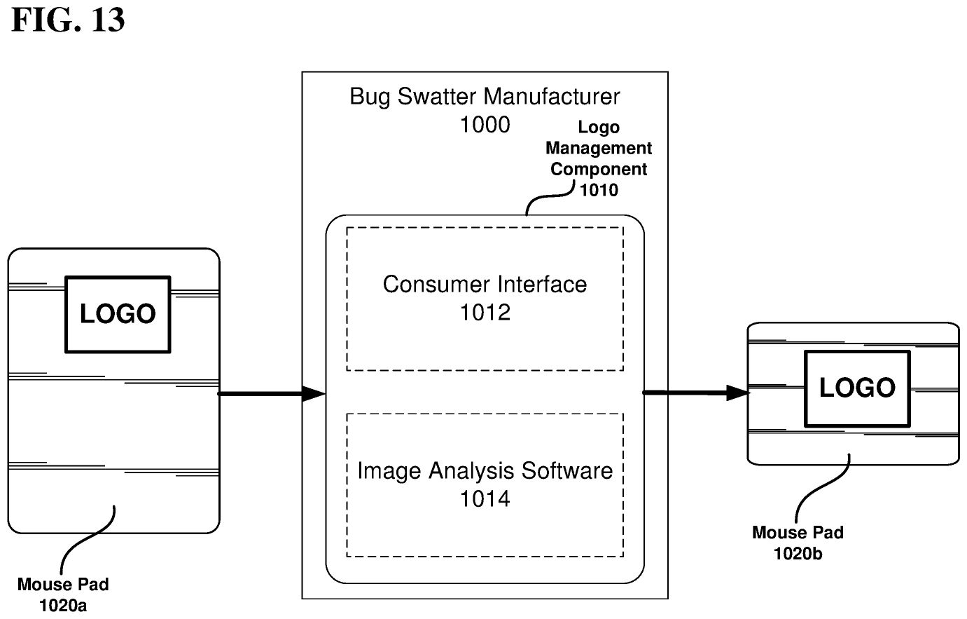

In another aspect disclosed herein, it is contemplated that the obtaining performed at act 1410 may comprise obtaining at least one mouse pad that includes a pre-existing logo, wherein the creating performed at act 1420 comprises ensuring that at least a portion of the pre-existing logo remains visible in the repurposed form of the at least one mouse pad. For instance, as illustrated in FIG. 13, bug swatter manufacturer 1000 may obtain a mouse pad 1020a that includes a pre-existing logo, wherein a logo management component 1010 is configured to determine a primary portion of the pre-existing logo. The creating performed at act 1420 may then further comprise cutting the original mouse pad 1020a so that the primary portion of the pre-existing logo remains visible in the repurposed form of the mouse pad 1020b, as shown. In a particular embodiment, logo management component 1010 may include a consumer interface 1012, wherein the consumer may determine the primary portion of the pre-existing logo (e.g., via cropping tools). Alternatively, logo management component 1010 may include image analysis software 1014, wherein the determining comprises utilizing an image recognition computer algorithm to identify the primary portion of the pre-existing logo in an automated manner.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components coupled to other components rather than included within parent components (hierarchical). Additionally, it is noted that one or more components may be combined into a single component providing aggregate functionality or divided into several separate sub-components, and any one or more middle layers may be provided to couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the various figures. While for purposes of simplicity of explanation, the methodologies are described as a series of steps, it is to be understood and appreciated that the disclosed subject matter is not limited by the order of the steps, as some steps may occur in different orders and/or concurrently with other steps from what is described herein. Moreover, not all disclosed steps may be required to implement the methodologies described hereinafter.

While the various embodiments have been described in connection with the exemplary embodiments of the various figures, it is to be understood that other similar embodiments may be used or modifications and additions may be made to the described embodiment for performing the same function without deviating there from. Therefore, the present invention should not be limited to any single embodiment.

What is claimed is:

1. A bug swatter apparatus, comprising:
a handle; and
at least one flappable pad coupled to the handle, wherein a portion of the at least one flappable pad is configured to flap behind the handle when the handle is swung.

2. The bug swatter apparatus according to claim 1, wherein the flappable pad is made of at least one of rubber, neoprene, leather, or elastomer.

3. The bug swatter apparatus according to claim 1, wherein the flappable pad has a thickness of at least one millimeter.

4. The bug swatter apparatus according to claim 1, wherein the flappable pad has a density of at least 1150 kg/m³.

5. The bug swatter apparatus according to claim 1, further comprising a second flappable pad coupled to the handle and the at least one flappable pad, the second flappable pad having a weight and dimensions substantially similar to the at least one flappable pad.

6. The bug swatter apparatus according to claim 1, further comprising a rigid support component coupled to the handle and the at least one flappable pad, the rigid support component having a lesser area than the at least one flappable pad.

7. The bug swatter apparatus according to claim 1, wherein the handle is coupled to the at least one flappable pad via an insertion of the handle into a side of the at least one flappable pad.

8. A bug swatter apparatus, comprising:
a handle; and
a flat surface coupled to the handle, wherein the flat surface comprises at least one layer of adhesive material.

9. The bug swatter apparatus according to claim 8, further comprising a peelable backing coupled to the at least one layer of adhesive material, wherein the peelable backing is configured to seal the adhesive material until the peelable backing is removed.

10. The bug swatter apparatus according to claim 8, wherein the flat surface comprises a plurality of removable layers of adhesive material.

11. The bug swatter apparatus according to claim 10, wherein the plurality of removable layers of adhesive material are layered on one side of the flat surface.

12. The bug swatter apparatus according to claim 10, wherein the plurality of removable layers of adhesive material are wrapped around the flat surface.

13. The bug swatter apparatus according to claim 12, wherein the plurality of removable layers of adhesive material comprises a plurality of perforations.

14. A method that facilitates repurposing mouse pads, comprising:
obtaining at least one mouse pad; and
creating a repurposed form of the at least one mouse pad, wherein the creating comprises attaching the at least one mouse pad to a handle.

15. The method according to claim 14, wherein the obtaining comprises sourcing the at least one mouse pad from a repository of discarded mouse pads.

16. The method according to claim 14, wherein the obtaining comprises sourcing the at least one mouse pad from a repository of overstocked mouse pads.

17. The method according to claim 14, further comprising selling the repurposed form of the at least one mouse pad to a source of the at least one mouse pad.

18. The method according to claim 14, wherein the obtaining comprises obtaining at least one mouse pad that includes a pre-existing logo, and wherein the creating comprises ensuring that at least a portion of the pre-existing logo remains visible in the repurposed form of the at least one mouse pad.

19. The method according to claim 18, further comprising determining a primary portion of the pre-existing logo, wherein the creating further comprises cutting the at least one mouse pad so that the primary portion of the pre-existing logo remains visible in the repurposed form of the at least one mouse pad.

20. The method according to claim 19, wherein the determining comprises utilizing an image recognition computer algorithm to identify the primary portion of the pre-existing logo.
